(19) United States
(12) Patent Application Publication
(10) Pub. No.: US 2015/0146596 A1
(43) Pub. Date: May 28, 2015

(54) Method and Apparatus for Transmitting Indication in Wireless Communication System

(71) Applicant: LG Electronics Inc., Seoul (KR)

(72) Inventors: Daewook Byun, Seoul (KR); Jian Xu, Seoul (KR); Kyungmin Park, Seoul (KR)

(73) Assignee: LG Electronics Inc., Seoul (KR)

(21) Appl. No.: 14/405,882

(22) PCT Filed: Aug. 1, 2013
(86) PCT No.: PCT/KR2013/006965

§ 371 Date: Dec. 5, 2014

Related U.S. Application Data
(60) Provisional application No. 61/679,078, filed on Aug. 3, 2012.

(51) Int. Cl. H04W 52/02; H04W 36/00

(52) U.S. Cl. CPC H04W 52/0206; H04W 36/0005
USPC 370/311

(57) ABSTRACT

A method and apparatus for transmitting an indication in a wireless communication system is provided. A first eNodeB (eNB) transmits an X2 setup request message or an X2 setup response message to a second eNB, receives a cell activation request message from the second eNB, and transmits a cell activation response message to the second eNB. At least one of the X2 setup request message, the X2 setup response message, and the cell activation response message includes an indication which indicates whether the first eNB supports a probing state or not.

### BACKGROUND OF THE INVENTION

1. Field of the Invention

The present invention relates to wireless communication, and more particularly, to a method and apparatus for transmitting an indication in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows network structure of an evolved universal mobile telecommunication system (E-UMTS). The E-UMTS may be also referred to as an LTE system. The communication network is widely deployed to provide a variety of communication services such as voice over internet protocol (VoIP) through IMS and packet data.

As shown in FIG. 1, the E-UMTS network includes an evolved UMTS terrestrial radio access network (E-UTRAN), an evolved packet core (EPC) and one or more user equipment. The E-UTRAN may include one or more evolved NodeB (eNB) 20, and a plurality of user equipment (UE) 10. One or more E-UTRAN mobility management entity (MME)/system architecture evolution (SAE) gateways (S-GW) 30 may be positioned at the end of the network and connected to an external network.

As used herein, “downlink” refers to communication from eNB 20 to UE 10, and “uplink” refers to communication from the UE to an eNB. UE 10 refers to communication equipment carried by a user and may be also referred to as a mobile station (MS), a user terminal (UT), a subscriber station (SS) or a wireless device.

An eNB 20 provides end points of a user plane and a control plane to the UE 10. MME/S-GW 30 provides an end point of a session and mobility management function for UE 10. The eNB and MME/S-GW may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including non-access stratum (NAS) signaling to eNBs 20, NAS signaling security, access stratum (AS) security control, Inter core network (CN) node signaling for mobility between 3GPP access networks, Idle mode UE reachability (including control and execution of paging retransmission), tracking area list management (for UE in idle and active mode), packet data network (PDN) GW and serving GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g. deep packet inspection), lawful interception, UE internet protocol (IP) address allocation, transport level packet marking in the downlink, UL and DL service level charging, gating and rate enforcement, DL rate enforcement based on APN-AMBR. For clarity MME/S-GW 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

FIG. 2 shows architecture of a typical E-UTRAN and a typical EPC.

As shown, eNB 20 may perform functions of selection for gateway 30, routing toward the gateway during a radio resource control (RRC) activation, scheduling and transmitting of paging messages, scheduling and transmitting of broadcast channel (BCH) information, dynamic allocation of resources to UEs 10 in both uplink and downlink, configuration and provisioning of eNB measurements, radio bearer control, radio admission control (RAC), and connection mobility control in LTE ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 3 shows a user-plane protocol and a control-plane protocol stack for the E-UMTS.

FIG. 3(a) is block diagram depicting the user-plane protocol, and FIG. 3(b) is block diagram depicting the control-plane protocol. As shown, the protocol layers may be divided into a first layer (L1), a second layer (L2) and a third layer (L3) based upon the three lower layers of an open system interconnection (OSI) standard model that is well known in the art of communication systems.

The physical layer, the L1, provides an information transmission service to an upper layer by using a physical channel. The physical layer is connected with a medium access control (MAC) layer located at a higher level through a transport channel, and data between the MAC layer and the physical layer is transferred via the transport channel. Between different physical layers, namely, between physical layers of a transmission side and a reception side, data is transferred via the physical channel.

The MAC layer of the L2 provides services to a radio link control (RLC) layer (which is a higher layer) via a logical channel. The RLC layer of the L2 supports the transmission of data with reliability. It should be noted that the RLC layer shown in FIGS. 3(a) and 3(b) is depicted because if the RLC functions are implemented in and performed by the MAC layer, the RLC layer itself is not required. A packet data convergence protocol (PDCP) layer of the L2 performs a header compression function that reduces unnecessary control information such that data being transmitted by employing IP packets, such as IPv4 or IPv6, can be efficiently sent over a radio (wireless) interface that has a relatively small bandwidth.

A radio resource control (RRC) layer located at the lowest portion of the L3 is only defined in the control plane and controls logical channels, transport channels and the physical channels in relation to the configuration, reconfiguration, and release of the radio bearers (RBs). Here, the RB signifies a service provided by the L2 for data transmission between the terminal and the UTRAN.

As shown in FIG. 3(a), the RLC and MAC layers (terminated in an eNB 20 on the network side) may perform functions such as scheduling, automatic repeat request (ARQ), and hybrid automatic repeat request (HARQ). The PDCP layer (terminated in eNB 20 on the network side) may perform the user plane functions such as header compression, integrity protection, and ciphering.

As shown in FIG. 3(b), the RLC and MAC layers (terminated in an eNodeB 20 on the network side) perform the same functions for the control plane. As shown, the RRC layer (terminated in an eNB 20 on the network side) may perform functions such as broadcasting, paging, RRC connection management, RB control, mobility functions, and UE measurement reporting and controlling. The NAS control protocol (terminated in the MME of gateway 30 on the network side) may perform functions such as a SAE bearer management, authentication, LTE_IDLE mobility handling, paging origination in LTE_IDLE, and security control for the signaling between the gateway and UE 10.

The RRC state may be divided into two different states such as a RRC_IDLE and a RRC_CONNECTED. In RRC_IDLE state, the UE 10 may receive broadcasts of system information and paging information while the UE specifies a discontinuous reception (DRX) configured by NAS, and the UE has been allocated an identification (ID) which uniquely identifies the UE in a tracking area and may perform PLMN selection and cell re-selection. Also, in RRC_IDLE state, no RRC context is stored in the eNB.

In RRC_CONNECTED state, the UE 10 has an E-UTRAN RRC connection and a context in the E-UTRAN, such that transmitting and/or receiving data to/from the network (eNB) becomes possible. Also, the UE 10 can report channel quality information and feedback information to the eNB.

In RRC_CONNECTED state, the E-UTRAN knows the cell to which the UE 10 belongs. Therefore, the network can transmit and/or receive data to/from UE 10, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE 10 specifies the paging DRX cycle. Specifically, the UE 10 monitors a paging signal at a specific paging occasion of every UE specific paging DRX cycle.

The paging occasion is a time interval during which a paging signal is transmitted. The UE 10 has its own paging occasion.

A paging message is transmitted over all cells belonging to the same tracking area. If the UE 10 moves from one tracking area to another tracking area, the UE will send a tracking area update message to the network to update its location.

FIG. 4 shows an example of structure of a physical channel.

The physical channel transfers signaling and data between layer L1 of a UE and eNB. As shown in FIG. 4, the physical channel transfers the signaling and data with a radio resource, which consists of one or more sub-carriers in frequency and one more symbols in time.

One sub-frame, which is 1 ms in length, consists of several symbols. The particular symbol(s) of the sub-frame, such as the first symbol of the sub-frame, can be used for downlink control channel (PDCCH). PDCCHs carry dynamic allocated resources, such as PRBs and modulation and coding scheme (MCS).

A transport channel transfers signaling and data between the L1 and MAC layers. A physical channel is mapped to a transport channel.

Downlink transport channel types include a broadcast channel (BCH), a downlink shared channel (DL-SCH), a paging channel (PCH) and a multicast channel (MCH). The BCH is used for transmitting system information. The DL-SCH supports HARQ, dynamic link adaptation by varying the modulation, coding and transmit power, and both dynamic and semi-static resource allocation. The DL-SCH also may enable broadcast in the entire cell and the use of beamforming. The PCH is used for paging a UE. The MCH is used for multicast or broadcast service transmission.

Uplink transport channel types include an uplink shared channel (UL-SCH) and random access channel(s) (RACH). The UL-SCH supports HARQ and dynamic link adaptation by varying the transmit power and potentially modulation and coding. The UL-SCH also may enable the use of beamforming. The RACH is normally used for initial access to a cell.

The MAC sublayer provides data transfer services on logical channels. A set of logical channel types is defined for different data transfer services offered by MAC. Each logical channel type is defined according to the type of information transferred.

Logical channels are generally classified into two groups. The two groups are control channels for the transfer of control plane information and traffic channels for the transfer of user plane information.

Control channels are used for transfer of control plane information only. The control channels provided by MAC include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by MAC include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include a DCCH that can be mapped to UL-SCH, a DTCH that can be mapped to UL-SCH and a CC CH that can be mapped to UL-SCH. Downlink connections between logical channels and transport channels include a BCCH that can be mapped to BCH or DL-SCH, a PCCH that can be mapped to PCH, a DCCH that can be mapped to DL-SCH, and a DTCH that can be mapped to DL-SCH, a MCCH that can be mapped to MCH, and a MTCH that can be mapped to MCH.

Recently, efforts to reduce a greenhouse effect and environmental degradation by excessive emissions of carbon dioxide have been increased. Accordingly, in wireless communications, issues of reducing power of base stations, which are main cause of emissions of carbon dioxide, and using the power of base stations efficiently have been discussed importantly. That is, until now, it is a focus of discussion of wireless communications that reducing power of user equipments in order to improve portability. But, in the future, reducing the power of base stations and increasing efficiency of the power of base stations may be subject to critical discussion. As a result, emissions of carbon dioxide, as well as operational costs (OPEX), can be reduced. In 3GPP, discussion of energy saving from the point of view of base stations has started from rel-9, and in rel-11, technologies considering energy efficiency have been discussed in an environment in which various types of base stations are deployed.

### SUMMARY OF THE INVENTION

The present invention provides a method for transmitting an indication in a wireless communication system. The present invention provides a method for indicating a state of a hotspot cell for energy saving. The present invention also provides a method for a coverage cell differentiating nodes supporting probing mechanism from those without that function.

In an aspect, a method for transmitting, by a first eNodeB (eNB), an indication in a wireless communication system is provided. The method includes transmitting an X2 setup request message or an X2 setup response message to a second eNB, receiving a cell activation request message from the second eNB, and transmitting a cell activation response message to the second eNB. At least one of the X2 setup request message, the X2 setup response message, and the cell activation response message includes an indication which indicates whether the first eNB supports a probing state or not.

The first eNB may be an eNB owning a capacity booster cell.

The second eNB may be an eNB owning a non-capacity booster cell.

The probing state may be a state that the first eNB prevents idle mode user equipments (UEs) from camping on a cell served by the first eNB and prevents incoming handovers to the cell.

The method may further include entering the probing state after transmitting the cell activation response message if the first eNB supports the probing state.

The cell activation request message may include a probing timer value.

In another aspect, a first eNodeB (eNB) in a wireless communication system is provided. The first eNB includes a radio frequency (RF) unit for transmitting or receiving a radio signal, and a processor coupled to the RF unit, and configured for transmitting an X2 setup request message or an X2 setup response message to a second eNB, receiving a cell activation request message from the second eNB, and transmitting a cell activation response message to the second eNB. At least one of the X2 setup request message, the X2 setup response message, and the cell activation response message includes an indication which indicates whether the first eNB supports a probing state or not.

A coverage cell can differentiate nodes supporting probing mechanism from those not supporting the probing mechanism.

### BRIEF DESCRIPTION OF THE DRAWINGS

FIG. 1 shows network structure of an evolved universal mobile telecommunication system (E-UMTS).

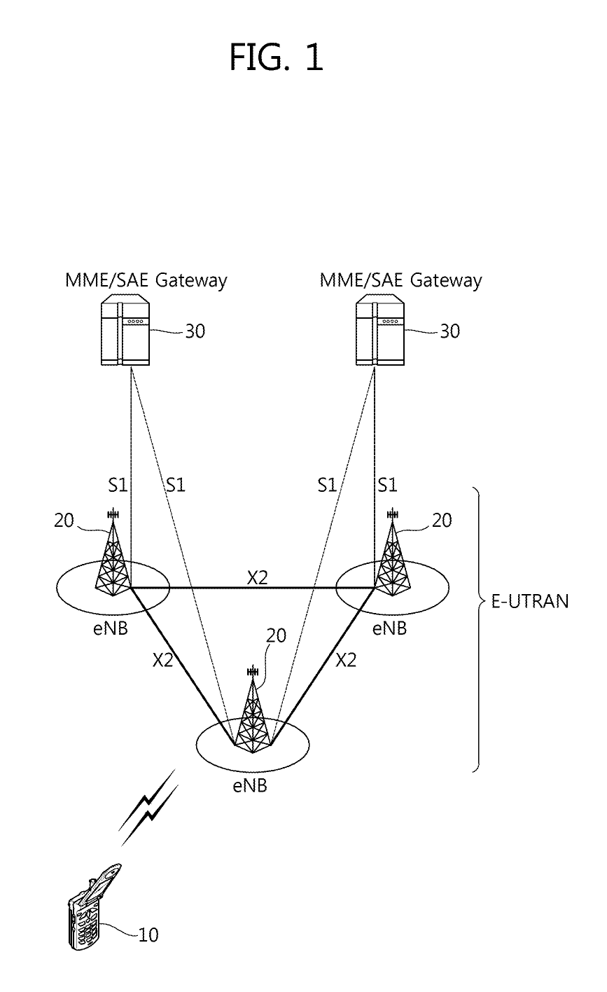

FIG. 2 shows architecture of a typical E-UTRAN and a typical EPC.

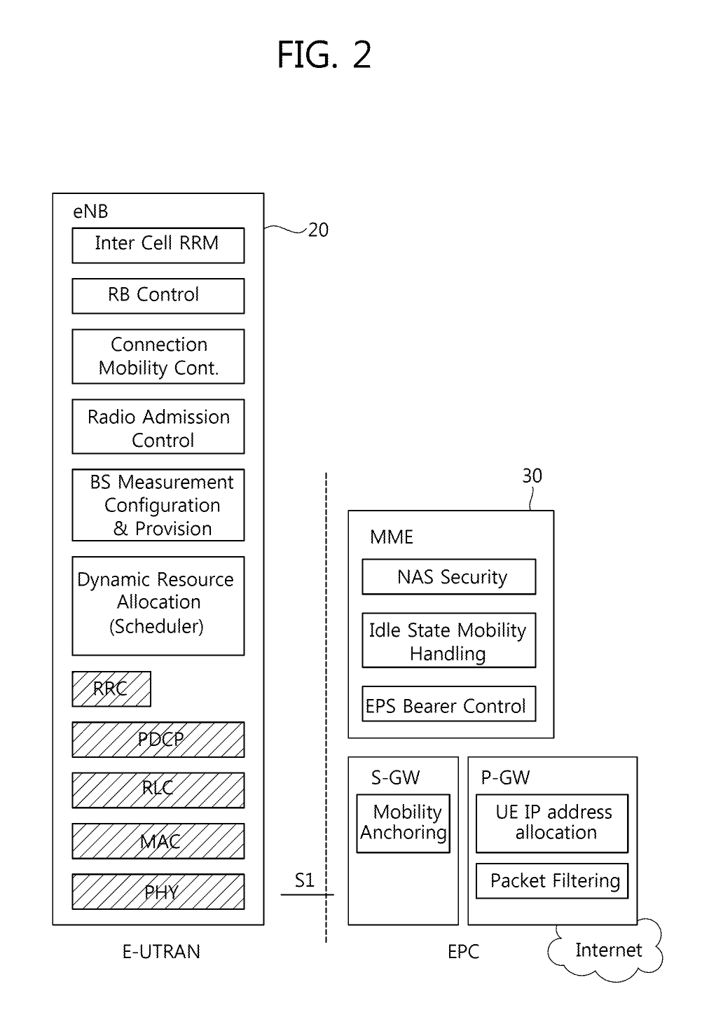

FIG. 3 shows a user-plane protocol and a control-plane protocol stack for the E-UMTS.

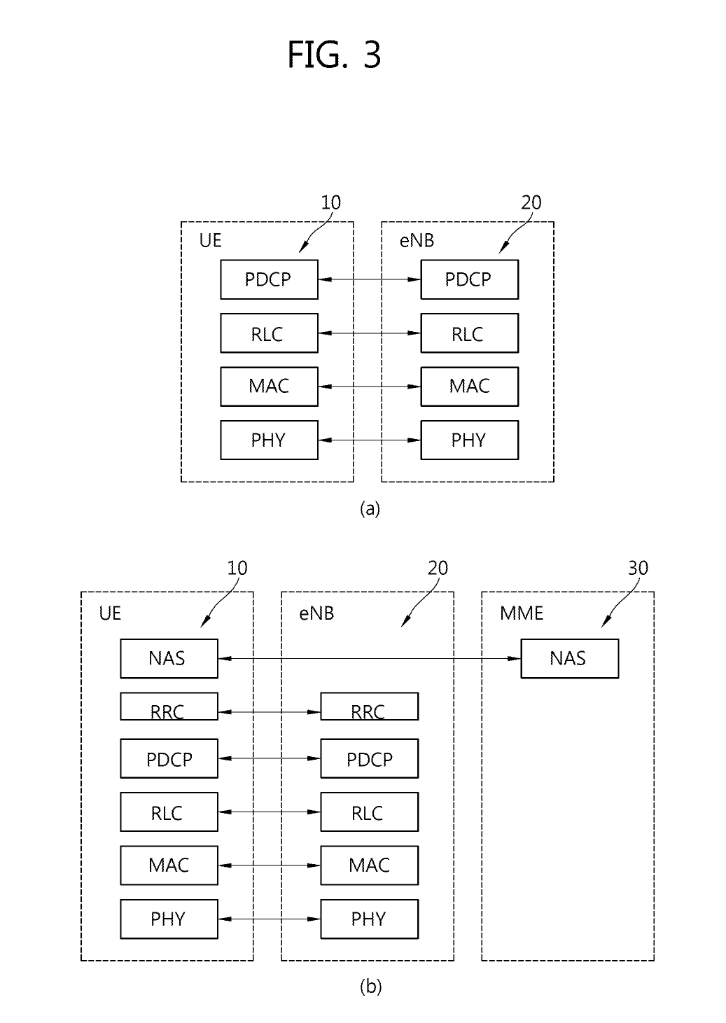

FIG. 4 shows an example of structure of a physical channel.

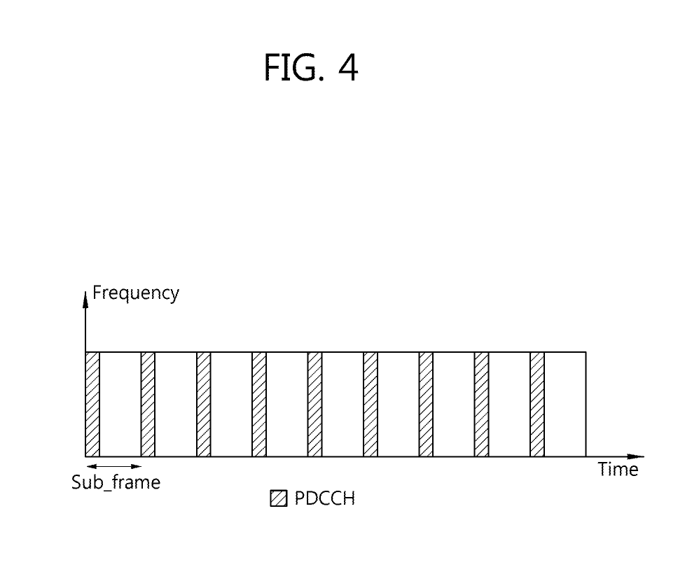

FIG. 5 shows an X2 setup procedure.

FIG. 6 shows a cell activation procedure.

FIG. 7 shows an example of an inter-eNBs environment for energy saving.

FIG. 8 shows an example of a method for energy saving using a hotspot cell in an inter-eNB environment.

FIG. 9 shows another example of a method for energy saving using a hotspot cell in an inter-eNB environment.

FIG. 10 shows another example of a method for energy saving using a hotspot cell in an inter-eNB environment.

FIG. 11 shows an example of a method for transmitting an indication according to an embodiment of the present invention.

FIG. 12 shows another example of a method for transmitting an indication according to an embodiment of the present invention.

FIG. 13 is a block diagram showing wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

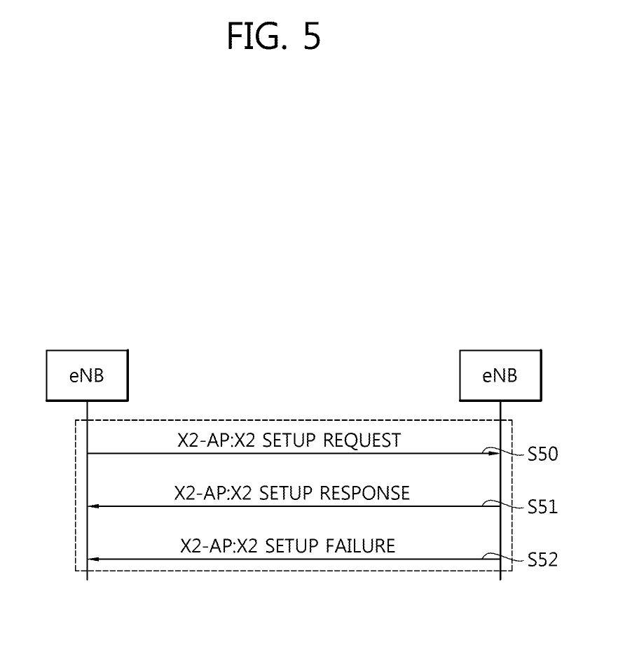

FIG. 5 shows an X2 setup procedure. The purpose of the X2 setup procedure is to exchange application level data needed for two eNodeBs (eNBs) to interoperate correctly over an X2 interface.

Referring to FIG. 5, at step S50, a first eNB transmits an X2 setup request message to a second eNB. If the second eNB accepts the X2 setup request message from the first eNB, at step S51, the second eNB transmits an X2 setup response message to the first eNB. If the second eNB cannot accept the X2 setup request message from the first eNB, at step S52, the second eNB transmits an X2 setup failure message to the first eNB.

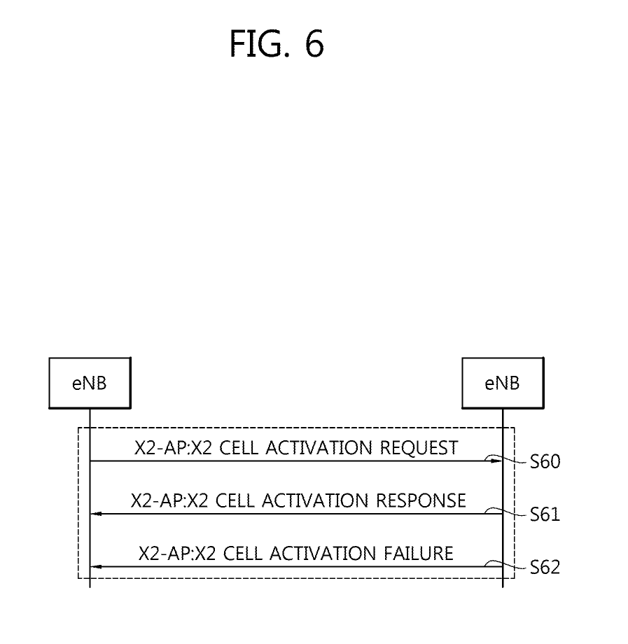

FIG. 6 shows a cell activation procedure. The purpose of the cell activation procedure is to enable an eNB to transmit a cell activation request message to a peer eNB to request re-activation of one or more cells, controlled by the peer eNB and which had been previously indicated as dormant.

Referring to FIG. 6, at step S60, a first eNB transmits a cell activation request message to a second eNB. If the second eNB accepts the cell activation request message from the first eNB, at step S61, the second eNB transmits a cell activation response message to the first eNB. If the second eNB cannot accept the cell activation request message from the first eNB, at step S62, the second eNB transmits a cell activation failure message to the first eNB.

Various methods for energy saving using a hotspot cell in an inter-eNB environment are described below.

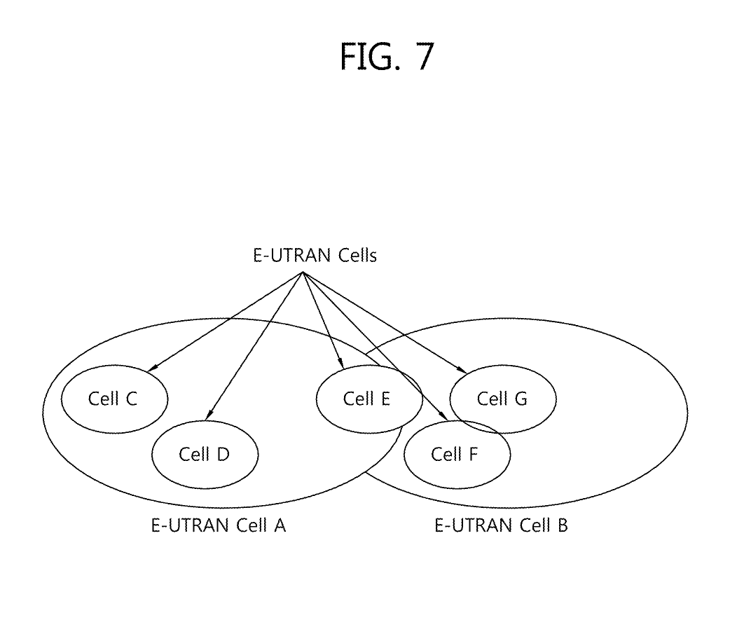

FIG. 7 shows an example of an inter-eNBs environment for energy saving.

Referring to FIG. 7, E-UTRAN cell A and E-UTRAN cell B are coverage-providing cells which provides basic coverage. The E-UTRAN cell A and E-UTRAN cell B have larger coverage relatively. The coverage-providing cell may be called a non-capacity booster cell. E-UTRAN cell C to E-UTRAN cell G are hotspot cells which is switched-on under the necessity of the coverage-providing cell, and is switched-off if loads are below a certain level. The E-UTRAN cell C to E-UTRAN cell G have smaller coverage than the E-UTRAN cell A and E-UTRAN cell B. The hotspot cell may be called a capacity booster cell. Usually, a hotspot eNB serving a hotspot cell is in a dormant state in which the hotspot eNB does not operate as an eNB. The hotspot eNB may transit from the dormant state to an active state, in which the hotspot eNB operates as an eNB, by a request of a coverage-providing cell.

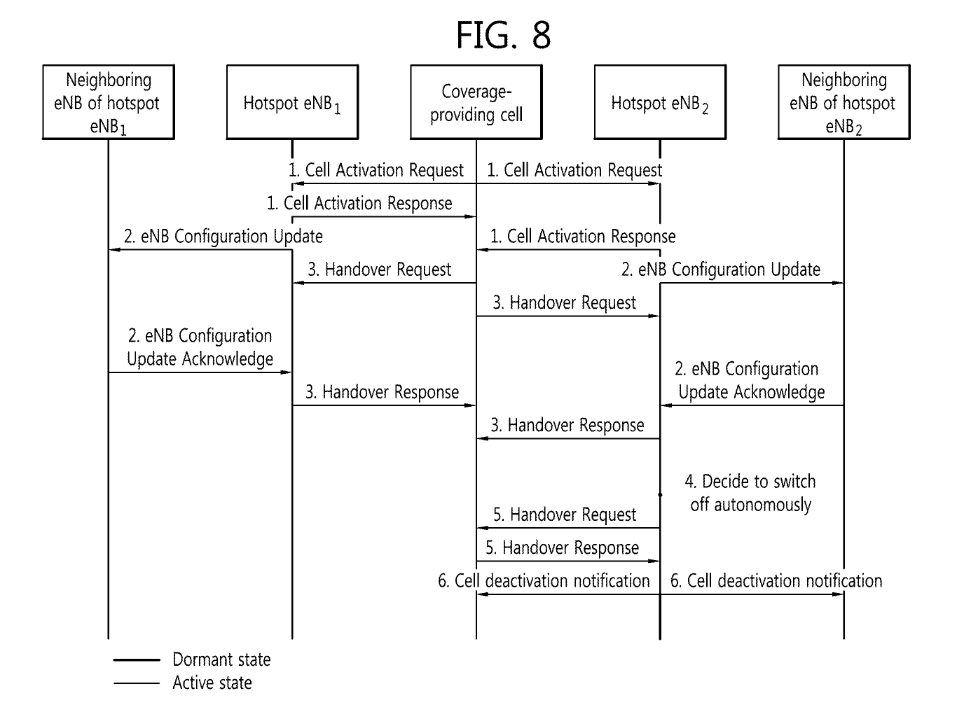

FIG. 8 shows an example of a method for energy saving using a hotspot cell in an inter-eNB environment. The method for energy saving shown in FIG. 8 may be called ‘rel-9 based solution’, or for convenience, may be called a first solution.

1. It is assumed that a hotspot cell 1 and a hotspot cell 2 are in a dormant state. If loads of a coverage-providing cell is above a certain level, the coverage-proving cell transmits a cell activation request message to a hotspot eNB1 and a hotspot eNB2, which have a relationship with the coverage-providing cell, to reduce the loads of the coverage-providing cell. Upon receiving the cell activation request message, the hotspot eNB1 and the hotspot eNB2 transmit a cell activation response message to the coverage-providing cell, respectively. By receiving the cell activation request message, the hotspot cell 1 and the hotspot cell 2 transit from the dormant state to an active state.

2. The hotspot eNB1 and the hotspot eNB2 transmit an eNB configuration update message to neighboring eNBs, respectively. Upon receiving the eNB configuration update message, the neighboring eNBs of the hotspot eNB 1 and the hotspot eNB2 transmit an eNB configuration update acknowledge message to the hotspot eNB 1 and the hotspot eNB2, respectively. The hotspot eNB 1 and the hotspot eNB2 may notify the neighboring eNBs that the hotspot cell 1 and 2 are in the active state.

3. The coverage-providing cell transmits a handover request message to the hotspot eNB1 and the hotspot eNB2. Upon receiving the handover request message, the hotspot eNB 1 and the hotspot eNB2 transmit a handover response message to the coverage-providing cell, respectively. UEs served by the coverage-providing cell are handed over to the hotspot cell 1 and 2. Accordingly, the coverage-providing cell can handover the loads of the coverage-providing cell to the hotspot cell 1 and 2.

4. The hotspot eNB2 decides to switch-off autonomously. The hotspot eNB 2 can decide to switch-off when load of the hotspot cell 2 is below a certain level.

5. The hotspot eNB2 transmits a handover request message to the coverage-providing cell. Upon receiving the handover request message, the coverage-providing cell transmits a handover response message to the hotspot eNB2. UEs served by the hotspot cell 2 are handed over to the coverage-providing cell.

6. The hotspot eNB2 transmits a cell deactivation notification message to the coverage-providing cell and the neighboring cells. By transmitting the cell deactivation notification message, the hotspot eNB2 may notify that the hotspot eNB2 is switched-off. After transmitting the cell deactivation notification message, the hotspot cell 2 can transit from the active state to the dormant state.

However, the first solution described above in FIG. 8 has following problems:

1) The first solution results in a higher overall energy consumption in a network because suboptimal hotspot cell(s) remain activated unnecessarily. That is, as all hotspot cells having a relationship with the coverage-providing cell transit to the active state regardless of circumstances, overall energy consumption may be increased.

2) The hotspot cell in the first solution is fully activated by receiving a cell activation request message from the coverage-providing cell, and the hotspot cell transmits an eNB configuration update message to all its neighboring cells except the coverage-providing cell to which the hotspot cell transmits the cell activation response message. However, in case that the hotspot cell is activated only temporarily, signaling between the hotspot cell and its neighboring cells for the eNB configuration update procedure becomes unnecessary.

3) In the first solution, handover of UEs camping on the coverage-providing cell is performed after activation of hotspot cells having a relationship with the coverage-providing cell. Also, neighboring cells of hotspot cells may carry out handover toward the hotspot cells after transmitting an eNB configuration update acknowledge message to the hotspot cells. If at least one among the hotspot cells is activated only temporarily, then the traffic they have accepted before needs to be transferred to the coverage-providing cell or the neighboring cells. That is, when the hotspot cell transits to the dormant state, handover ping-pong problem may occur.

4) In case that the hotspot cell is activated by the coverage-providing cell in the first solution, new active sessions may be established and idle mode UEs from the coverage-providing cell or neighbor cells may reselect the hotspot cell. If the hotspot cell goes back to the dormant state or the hotspot cell is not chosen to remain in the active state, traffic the hotspot cell accepted and the idle mode UEs reselecting the hotspot cell should be transferred to the coverage-providing cell or the neighbor cells.

5) When the hotspot cell activated by the coverage-providing cell goes into the dormant state autonomously or the hotspot cell is not selected to remain in the active state, the first solution informs the coverage-providing cell and neighboring cells of deactivation of the hotspot cell. That is, additional signaling is required.

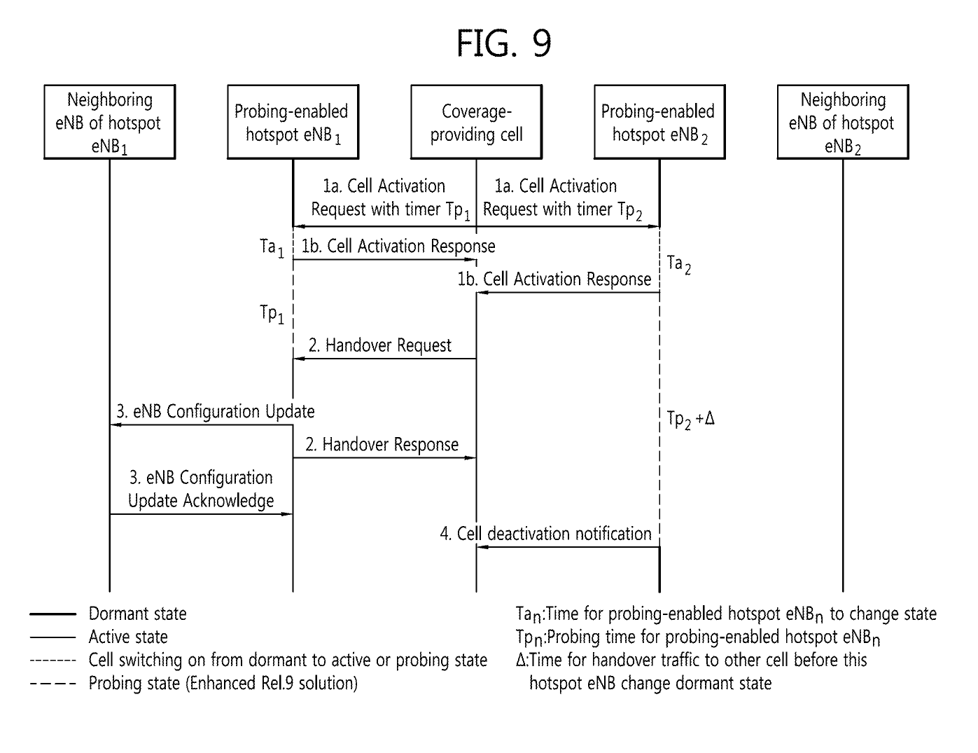

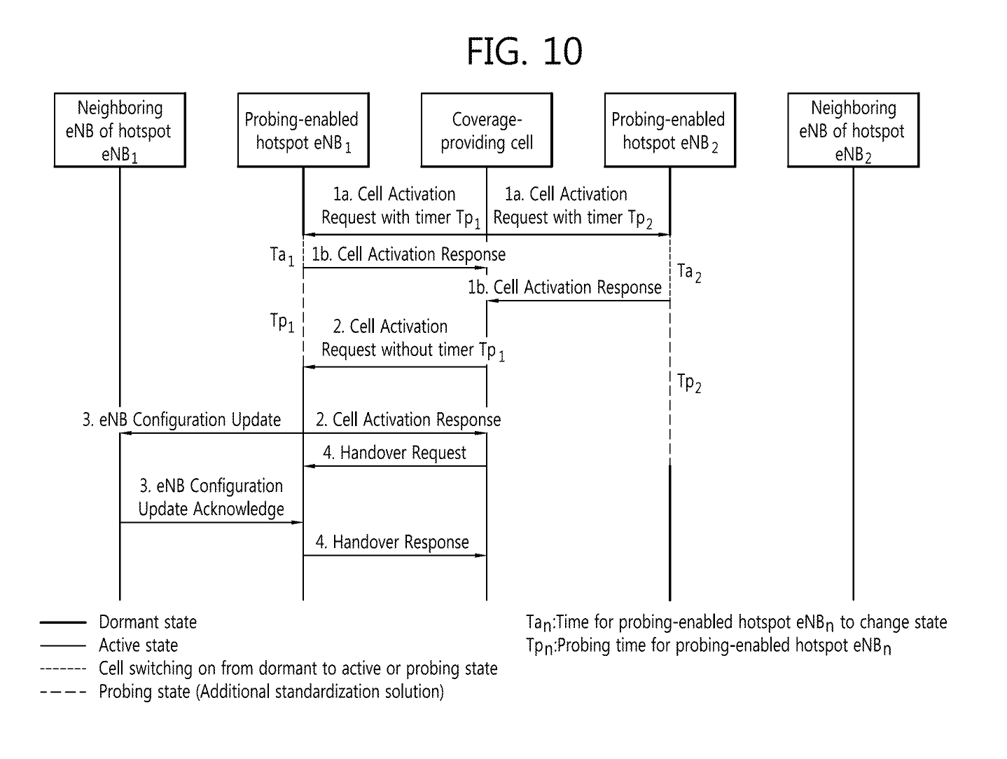

To overcome the problems of the first solution described above, other methods for energy saving using a hotspot cell in an inter-eNB environment may be proposed. That is, to solve the problems described above, methods for determining, by the coverage-providing cell, hotspot cells, which are actually need to be transited to the active state, using measurements of UEs for the hotspot cells may be proposed. It is described below in FIG. 9 and FIG. 10.

For this, a probing state and a probing-enabled hotspot cell may be newly defined. The probing-enabled hotspot cell is a cell which can support the probing state. The probing state is a state that the hotspot cell transmits a pilot signal and a cell barred indication on a downlink during a certain period, i.e. a probing period. In the probing state, the hotspot cell may prevent idle mode UEs from camping on the hotspot cell and may prevent incoming handovers from neighboring cells, including the coverage-providing cell, to the hotspot cell. By using the probing state, hotspot cells which are actually not used need not to transit to the active state, and unnecessary signaling procedure with neighboring cells and handover ping-pong problem can be prevented.

FIG. 9 shows another example of a method for energy saving using a hotspot cell in an inter-eNB environment. The method for energy saving shown in FIG. 9 may be called ‘enhanced rel-9 based solution’, or for convenience, may be called a second solution.

1a. It is assumed that a probing-enabled hotspot cell 1 and a probing-enabled hotspot cell 2 are in a dormant state. A coverage-proving cell transmits a cell activation request message to a probing-enabled hotspot eNB1 and a probing-enabled hotspot eNB2. The cell activation request message includes a probing timer value for each probing-enabled hotspot cell. That is, the cell activation request message transmitted to the probing-enabled hotspot eNB1 includes a probing timer value Tₚ₁ for the probing-enabled hotspot cell 1, and the cell activation request message transmitted to the probing-enabled hotspot eNB2 includes a probing timer value Tₚ₂ for the probing-enabled hotspot cell 2.

1b. Upon receiving the cell activation request message including the probing time value, the probing-enabled hotspot eNB 1 and the probing-enabled hotspot eNB2 wait by Tₐ₁ and Tₐ₂ respectively, and transmit a cell activation response message to the coverage-providing cell, respectively. After transmitting the cell activation response message, the probing timer for each probing-enabled hotspot cell (Tₚ₁, Tₚ₂) starts, and the probing-enabled hotspot cell 1 and 2 transit to the probing state.

2. The coverage-providing cell determines that a specific probing-enabled hotspot cell, among probing-enabled hotspot cells in the probing state, has to transit to the active state and has to operate as a hotspot cell. In FIG. 9, it is assumed that the specific probing-enabled hotspot cell is the probing-enabled hotspot cell 1.

Accordingly, the coverage-providing cell transmits a handover request message to the probing-enabled hotspot eNB 1 before the probing timer for the probing-enabled hotspot cell 1 (Tₚ₁) expires. Upon receiving the handover request message, the probing-enabled hotspot cell 1 can transit to the active state. The probing-enabled hotspot eNB1 transmits a handover response message to the coverage-providing cell. UEs served by the coverage-providing cell are handed over to the probing-enabled hotspot cell 1. Accordingly, the coverage-providing cell can handover the loads of the coverage-providing cell to the probing-enabled hotspot cell 1.

3. The probing-enabled hotspot eNB1 transmits an eNB configuration update message to neighboring eNBs. Upon receiving the eNB configuration update message, the neighboring eNBs of the probing-enabled hotspot eNB1 transmits an eNB configuration update acknowledge message to the probing-enabled hotspot eNB1. The probing-enabled hotspot eNB1 may notify the neighboring eNBs that the probing-enabled hotspot cell 1 is in the active state.

4. The probing-enabled hotspot cell 2 is a hotspot cell which does not have to transit to the active state. Accordingly, when the probing timer for the probing-enabled hotspot cell 2 (Tₚ₂) expires, the probing-enabled hotspot cell 2 transits to the dormant state again. The probing-enabled hotspot eNB2 transmits a cell deactivation notification message to the coverage-providing cell. By transmitting the cell deactivation notification message, the probing-enabled hotspot eNB2 may notify that the probing-enabled hotspot eNB2 is switched-off.

FIG. 10 shows another example of a method for energy saving using a hotspot cell in an inter-eNB environment. The method for energy saving shown in FIG. 10 may be called ‘additional standardization solution’, or for convenience, may be called a third solution.

1a. It is assumed that a probing-enabled hotspot cell 1 and a probing-enabled hotspot cell 2 are in a dormant state. A coverage-proving cell transmits a cell activation request message to a probing-enabled hotspot eNB1 and a probing-enabled hotspot eNB2. The cell activation request message includes a probing timer value for each probing-enabled hotspot cell. That is, the cell activation request message transmitted to the probing-enabled hotspot eNB1 includes a probing timer value Tₚ₁ for the probing-enabled hotspot cell 1, and the cell activation request message transmitted to the probing-enabled hotspot eNB2 includes a probing timer value Tₚ₂ for the probing-enabled hotspot cell 2.

1b. Upon receiving the cell activation request message including the probing time value, the probing-enabled hotspot eNB 1 and the probing-enabled hotspot eNB2 wait by Tₐ₁ and Tₐ₂ respectively, and transmit a cell activation response message to the coverage-providing cell, respectively. After transmitting the cell activation response message, the probing timer for each probing-enabled hotspot cell (Tₚ₁, Tₚ₂) starts, and the probing-enabled hotspot cell 1 and 2 transit to the probing state.

2. The coverage-providing cell determines that a specific probing-enabled hotspot cell, among probing-enabled hotspot cells in the probing state, has to transit to the active state and has to operate as a hotspot cell. In FIG. 10, it is assumed that the specific probing-enabled hotspot cell is the probing-enabled hotspot cell 1.

Accordingly, the coverage-providing cell transmits a cell activation request message without the probing timer value to the probing-enabled hotspot eNB 1, before the probing timer for the probing-enabled hotspot cell 1 (Tₚ₁) expires. Upon receiving the cell activation request message, the probing-enabled hotspot cell 1 can transit to the active state. The probing-enabled hotspot eNB1 transmits a cell activation response message to the coverage-providing cell.

3. The probing-enabled hotspot eNB1 transmits an eNB configuration update message to neighboring eNBs. Upon receiving the eNB configuration update message, the neighboring eNBs of the probing-enabled hotspot eNB1 transmits an eNB configuration update acknowledge message to the probing-enabled hotspot eNB 1. The probing-enabled hotspot eNB 1 may notify the neighboring eNBs that the probing-enabled hotspot cell 1 is in the active state.

4. The coverage-providing cell transmits a handover request message to the probing-enabled hotspot eNB 1. Upon receiving the handover request message, the probing-enabled hotspot eNB 1 transmits a handover response message to the coverage-providing cell. UEs served by the coverage-providing cell are handed over to the probing-enabled hotspot cell 1. Accordingly, the coverage-providing cell can handover the loads of the coverage-providing cell to the probing-enabled hotspot cell 1.

The probing-enabled hotspot cell 2 is a hotspot cell which does not have to transit to the active state. Accordingly, when the probing timer for the probing-enabled hotspot cell 2 (Tₚ₂) expires, the probing-enabled hotspot cell 2 transits to the dormant state again. The probing-enabled hotspot eNB2 does not need to transmit a cell deactivation notification message to the coverage-providing cell and neighboring cells.

The second solution and the third solution described above in FIG. 9 and FIG. 10 has some advantages over the first solution described in FIG. 8.

1) The second solution and the third solution prevent the hotspot cell from transmitting the eNB configuration update message unnecessarily as it enters into the probing state, which can transmit only pilot signals.

2) During the probing period, because the hotspot cell cannot accept handover from the coverage-providing cell and neighboring cells, handover ping-pong problem between the hotspot cell and the coverage-providing cell or neighboring cells does not happen.

3) In the third solution, during the probing period, because the hotspot cell broadcasts a cell barred indication, it is possible to avoid new active sessions being established and reselection of idle mode UEs from the coverage-providing cell or neighboring cells to the hotspot cell.

4) In the third solution, the probing-enabled hotspot cell does not need to inform the coverage-providing cell or neighboring cells of deactivation of the probing-enabled hotspot cell, because the coverage-providing cell knows that the probing timer value and the probing state of the probing-enabled hotspot cell is not available from the perspective of neighboring cells.

As described above, the second solution, and especially, the third solution have various merits over the first solution for energy saving. However, the second solution and the third solution described in FIG. 9 and FIG. 10 assumes that hotspot cells always support the probing state. In case that hotspot cells supporting the probing state and hotspot cells not supporting the probing state coexist, if the coverage-providing cell does not know whether hotspot cells, having a relationship with the coverage-providing cell, support the probing state or not, following problems may happen.

1) In the second and third solution, if the coverage-providing cell does not know whether hotspot cells, having a relationship with the coverage-providing cell, support the probing state or not, a cell activation request message including a probing timer value may be transmitted to a specific hotspot cell not supporting the probing state. Upon receiving the cell activation request message including the probing timer value, the specific hotspot cell not supporting the probing state may not be able to interpret the cell activation request message including the probing timer value, or may ignore the probing timer value included in the cell activation request message. If the specific hotspot cell cannot interpret the cell activation message including the probing timer value, the coverage-providing cell may acknowledge this error, and may determine that the specific hotspot cell cannot support the probing state. If the specific hotspot cell ignores the probing timer value included in the cell activation request message, the specific hotspot cell becomes fully activated. Accordingly, it is possible to accept handover request from neighboring cells and also new traffic from UEs covered by the hotspot cell. However, the coverage-providing cell still does not request handover toward the specific hotspot cell since the coverage-providing cell misunderstands that the specific hotspot cell is currently in the probing state. That is, problems of the first solution described above cannot be solved.

2) In the third solution, if the coverage-providing cell does not know whether hotspot cells support the probing state or not, a cell activation request message including a probing timer value may be transmitted to a specific hotspot cell not supporting the probing state. Upon receiving the cell activation request message including the probing timer value, the specific hotspot cell not supporting the probing state may not be able to interpret the cell activation request message including the probing timer value, or may ignore the probing timer value included in the cell activation request message. If the specific hotspot cell cannot interpret the cell activation message including the probing timer value, the coverage-providing cell may acknowledge this error, but delay from transmission of the cell activation request message to the acknowledgement of this error may occur. If the specific hotspot cell ignores the probing timer value included in the cell activation request message, the specific hotspot cell becomes fully activated. If this hotspot cell is determined to remain in the active state by the coverage-providing cell, the cell activation request message without the probing timer value is transmitted to the specific hotspot cell which is already fully activated. Upon receiving the cell activation request message, unknown errors or operation may occur. Or, upon receiving the cell activation request message, the specific hotspot cell can be switched-off and be switched-on again for cell activation, and service interruption may occur for UEs served by the specific hotspot cell.

Therefore, to solve the problem discussed above, a method for the coverage-providing cell differentiating hotspot cells supporting the probing state and hotspot cells not supporting the probing state may be required.

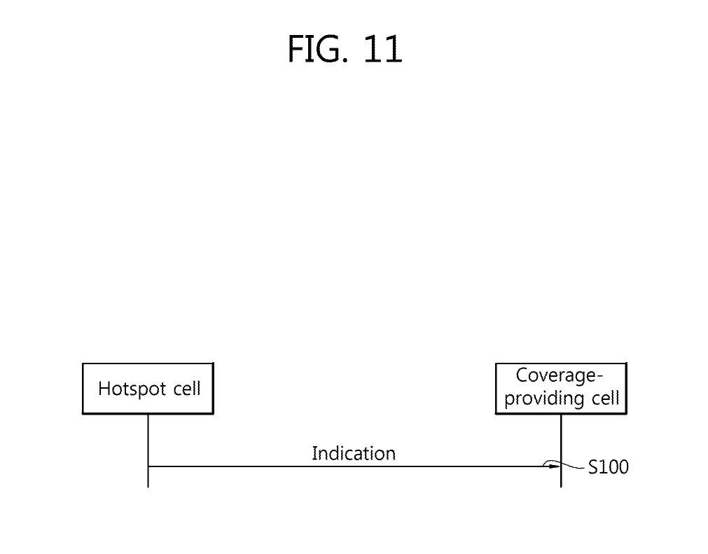

FIG. 11 shows an example of a method for transmitting an indication according to an embodiment of the present invention.

Referring to FIG. 11, at step S100, a hotspot cell transmits an indication, which indicates whether the hotspot cell supports a probing state or not, to a coverage-providing cell. The indication may be transmitted via an X2 setup request message. In other words, when the hotspot cell requests X2 setup to the coverage-providing cell, the indication, indicating whether the probing state is supported or not, is transmitted. Or, the indication may be transmitted via an X2 setup response message. In other words, when the hotspot cell responds to a request of X2 setup from the coverage-providing cell, the indication, indicating whether the probing state is supported or not, is transmitted. Or, the indication may be transmitted via a cell activation response message. In other words, when the hotspot cell responds to a cell activation request message from the coverage-providing cell, the indication, indicating whether the probing state is supported or not, is transmitted.

According to embodiments of the present invention, the coverage-providing cell can acknowledge whether each hotspot cell can support the probing state or not. Therefore, the coverage-providing cell can make only hotspot cells supporting the probing state transit to the active state. In addition, the coverage-providing cell may not transmit the cell activation request message without the probing timer value to hotspot cells not supporting the probing state.

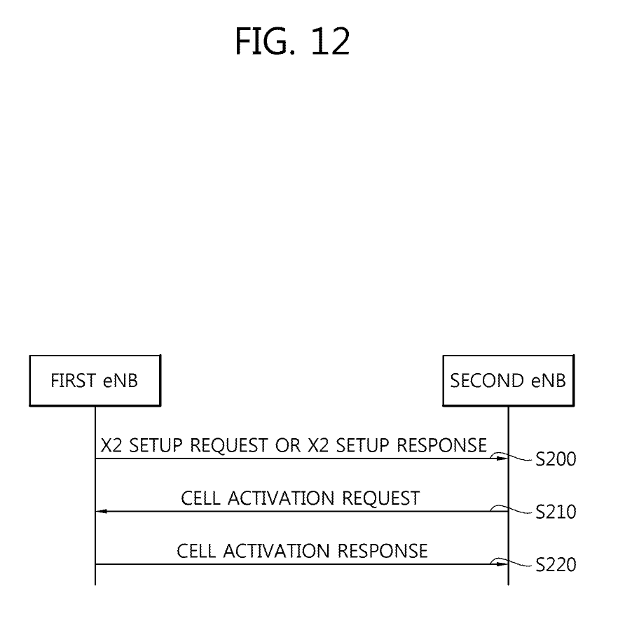

FIG. 12 shows another example of a method for transmitting an indication according to an embodiment of the present invention.

At step S200, a first eNB transmits an X2 setup request message or an X2 setup response message to a second eNB. At step S210, the first eNB receives a cell activation request message from the second eNB. At step S220, the first eNB transmits a cell activation response message to the second eNB. In this case, an indication which indicates whether the first eNB supports a probing state or not may be transmitted via at least one of the X2 setup request message, the X2 setup response message. The first eNB may be an eNB owning a capacity booster cell, and the second eNB may be an eNB owning a non-capacity booster cell. The first may enter the probing state after transmitting the cell activation response message if the first eNB supports the probing state.

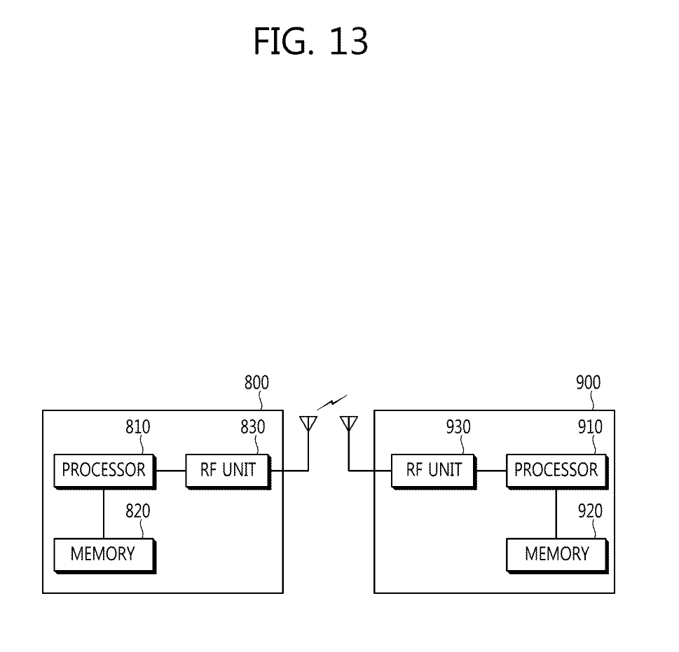

FIG. 13 is a block diagram showing wireless communication system to implement an embodiment of the present invention.

A first eNB 800 includes a processor 810, a memory 820, and an RF (radio frequency) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second eNB 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for transmitting, by a first eNodeB (eNB), an indication in a wireless communication system, the method comprising:
transmitting an X2 setup request message or an X2 setup response message to a second eNB;
receiving a cell activation request message from the second eNB; and
transmitting a cell activation response message to the second eNB;
wherein at least one of the X2 setup request message, the X2 setup response message, and the cell activation response message includes an indication which indicates whether the first eNB supports a probing state or not.

2. The method of claim 1, wherein the first eNB is an eNB owning a capacity booster cell.

3. The method of claim 1, wherein the second eNB is an eNB owning a non-capacity booster cell.

4. The method of claim 1, wherein the probing state is a state that the first eNB prevents idle mode user equipments (UEs) from camping on a cell served by the first eNB and prevents incoming handovers to the cell.

5. The method of claim 1, further comprising entering the probing state after transmitting the cell activation response message if the first eNB supports the probing state.

6. The method of claim 1, wherein the cell activation request message includes a probing timer value.

7. A first eNodeB (eNB) in a wireless communication system, the first eNB comprising:
a radio frequency (RF) unit for transmitting or receiving a radio signal; and
a processor coupled to the RF unit, and configured for:
transmitting an X2 setup request message or an X2 setup response message to a second eNB;
receiving a cell activation request message from the second eNB; and
transmitting a cell activation response message to the second eNB;
wherein at least one of the X2 setup request message, the X2 setup response message, and the cell activation response message includes an indication which indicates whether the first eNB supports a probing state or not.

8. The first eNB of claim 7, wherein the first eNB is an eNB owning a capacity booster cell.

9. The first eNB of claim 7, wherein the second eNB is an eNB owning a non-capacity booster cell.

10. The first eNB of claim 7, wherein the probing state is a state that the first eNB prevents idle mode user equipments (UEs) from camping on a cell served by the first eNB and prevents incoming handovers to the cell.

11. The first eNB of claim 7, wherein the processor is further configured for entering the probing state after transmitting the cell activation response message if the first eNB supports the probing state.

12. The first eNB of claim 7, wherein the cell activation request message includes a probing timer value.
